(19) United States
(12) Patent Application Publication
(10) Pub. No.: US 2012/0072885 A1
(43) Pub. Date: Mar. 22, 2012

(54) INTEGRATING USER INTERFACE COMPONENTS

(76) Inventors: Jonathan TARAGIN, Bet Shemesh (IL); Jecky Toledo, Kiryat Ono (IL); Harel Oshri, Hagor (IL)

(21) Appl. No.: 12/883,992

(22) Filed: Sep. 16, 2010

(51) Int. Cl. G06F 9/44

(52) U.S. Cl. 717/107

(57) ABSTRACT

A machine-readable storage medium includes executable instructions that, when executed, cause one or more processors to receive selection of a source component in a user interface mashup. The one or more processors are further caused to receive selection of a target component in the user interface mashup, the target component associated with a plurality of event types, and receive a first event from the source component, the first event associated with a first event type. The one or more processors are further caused to compare the first event type with the plurality of event types, and pass the first event to the target component if the plurality of event types comprises the first event type.

### BACKGROUND

Individuals deal with many different applications in many aspects of their lives. The information from the applications make up an individual's world, but the individual must jump between the applications to get a full view of his or her world. Businesses have a similar problem. Businesses deal with many different enterprise products, and each product has its own niche competitors. As such, when implemented, these products rarely communicate with one another especially if they are from different vendors.

### BRIEF DESCRIPTION OF THE DRAWINGS

For a detailed description of exemplary embodiments of the invention, reference will now be made to the accompanying drawings in which:

For a more complete understanding of the present disclosure, reference is now made to the accompanying drawings and detailed description, wherein like reference numerals represent like parts:

FIG. 1 illustrates a method in accordance with at least some illustrative embodiments;

FIGS. 2A-2C illustrate a storage medium, particular machine, and distributed processing system suitable for implementing one or more embodiments described herein in accordance with at least some illustrative embodiments;

FIG. 3 illustrates a storage medium and particular machine in accordance with at least some illustrative embodiments; and

FIG. 4 illustrates a user interface in accordance with at least some illustrative embodiments.

### NOTATION AND NOMENCLATURE

Certain terms are used throughout the following claims and description to refer to particular components. As one skilled in the art will appreciate, different entities may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean an optical, wireless, indirect electrical, or direct electrical connection. Thus, if a first device couples to a second device, that connection may be through an indirect electrical connection via other devices and connections, through a direct optical connection, etc. Additionally, the term “system” refers to a collection of two or more hardware components, and may be used to refer to an electronic device.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims, unless otherwise specified. In addition, one having ordinary skill in the art will understand that the following description has broad application, and the discussion of any embodiment is meant only to be exemplary of that embodiment, and not intended to intimate that the scope of the disclosure, including the claims, is limited to that embodiment.

Individuals are searching for a method of easily combining the highlights and content from disparate applications into a single unified workspace. In addition to displaying the data, this workspace should enable the different data sources to interact with each other. As such, searching or filtering in one application can trigger actions or a change in display in a second application. On the business side, there is added value created for making products communicate that did not previously communicate. For example, a business may want to create a workspace that shows a list of all hosts that are monitored by a business service management solution while simultaneously showing service manager trouble tickets related to those hosts and having the ticket list update concurrently with the host list. A lightweight, interactive, and easily customizable solution is needed.

A component is an application, program, script, or other executable code. Combining the output from one component with the input from another component creates an application called a “mashup.” In one embodiment, a user interface provides a mashup creator that allows a user to manipulate components graphically to create mashups in a workspace of the user interface. To do so, the user interface provides a standard mechanism for converting the output of a component written in any browser-compatible language such as Swing, Applet, Flex, JavaScript, HTML, XML, etc., into an input that another component can understand. The user interface allows the user to drag and drop components from a toolbox onto the workspace, and graphically map their inputs and outputs together to form the mashup. The user interface is able to integrate any web-based technology into a single integrated framework, even technologies written in different languages that have different event passing mechanisms. Specifically, the portion of the technology that communicates with the browser is exploited to pass events between technologies. As such, the user is able to link multiple components using graphical tools without being required to write code.

Examples of components for individuals are a stock ticker, a weather forecaster, a mapping service, etc. Examples of components for businesses are an inventory manager, a sales report, a network monitor, etc. Each workspace can handle multiple components and each component can be moved to form a customizable layout, which can be saved, recalled, modified, deleted, imported, exported, compressed, etc. Also, the user interface can be integrated into another application.

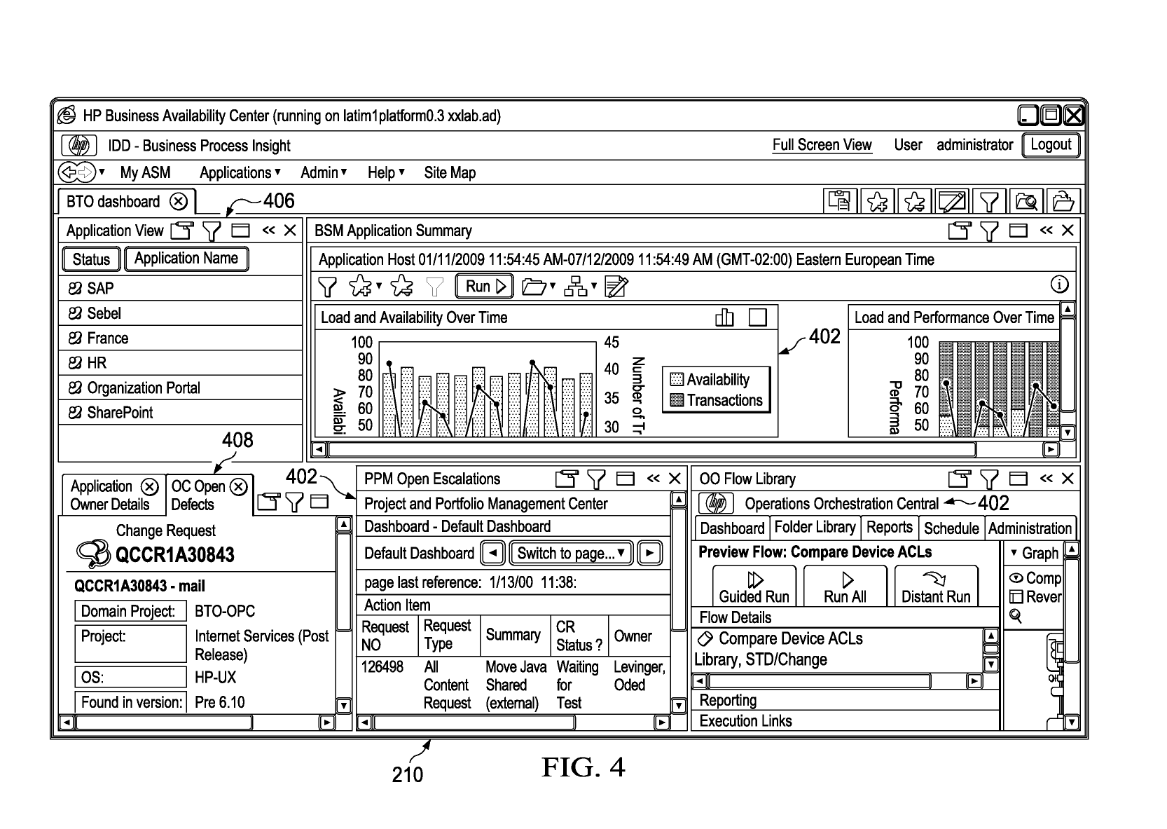

FIG. 4 illustrates a user interface 210. The mashup is built in a workspace. A workspace is the area in which a user arranges and connects all the content the user wishes to see. The components 402 can each comprise their own customizable window within the workspace or they may be free form. Tabs 408 can be added to each component 402 to organize information further. The components 402 in a workspace can be also be arranged by using one of several predefined templates.

Components 402 can be placed into the workspace from a displayed component gallery or toolbox 406. The toolbox 406 can be created in different ways. First, an application may be preloaded with a defined set of components 402. Second, components 402 may be imported into the toolbox 406 from files. Third, components 402 can be built by the user on the fly by specifying a content universal resource locater (“URL”) for the interface to reference the component.

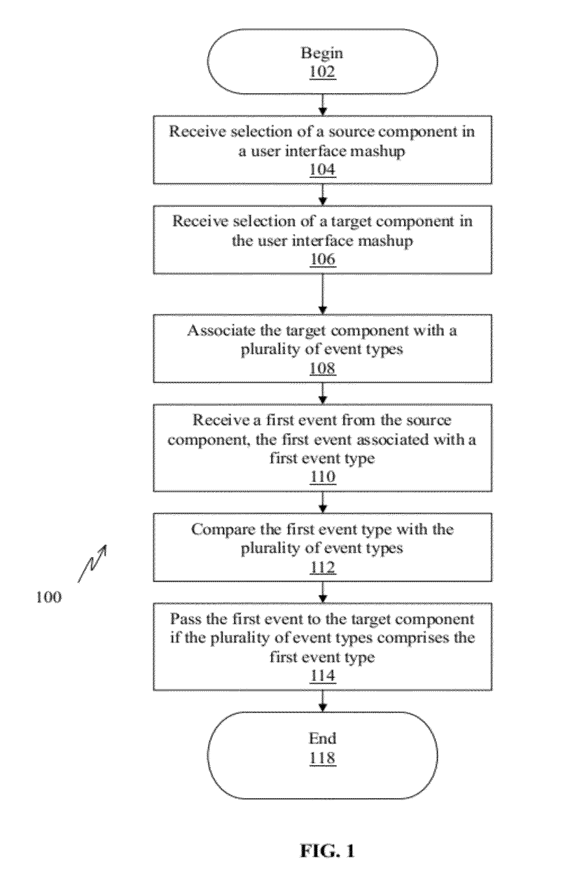

FIG. 1 illustrates a method 100 of passing information between components beginning at 102 and ending at 118. The actions can be performed in the order shown or in a different order, and may be performed by a processor or plurality of processors. A user can couple two components 402 using the interface 210 in order to command the components to communicate. At 104, selection of a source component 402 is received. For example, four components, a mapping component, a weather component, a stock ticker component, and a restaurant component are placed in the workspace. Using a mouse or pointer, the user clicks a wiring icon in the toolbox 406 representing the connecting function. Next, the user clicks on the mapping component. By virtue of being the first component to be selected, the mapping component is termed the source component. A source component provides its output to another component called the target component.

At 106, selection of a target component is received. For example, the user clicks on the weather component next. Preferably, the user sees an indication on the user interface 210 that the source component and target component are coupled. For example, a line or arrow appears between the source and target component.

The target component is associated with a plurality of event types. For example, the weather component is associated with the event types “location,” “temperature,” and “precipitation.” Such association can be loaded on the fly or preloaded into the user interface 210. At 108, a first event from the source component is received. For example, the user types the query “New York City” into the mapping component, which produces a map of New York City. The first event is associated with a first event type or multiple event types. For example, the mapping of New York City is associated with the event type “location.” A data of the first event is preferably “New York City.” At 110, the first event type is compared with the plurality of event types. For example, “location” is compared with “location,” “temperature,” and “precipitation.” At 114, the first event is passed to the target component if the plurality of event types comprises the first event type. If the plurality of event types does not comprise the first event type, the first event is blocked from passing to the target component. For example, because “location” is an event type that the weather component understands, the data “New York City” is passed to the weather component. Consequently, upon updating, the weather for New York City will be displayed by the weather component. In at least one embodiment, passing the first event comprises passing a JavaScript event to the target component. Alternatively, passing the first event comprises generating a URL based on the first event and the target component. For example, if the weather component is known to have a URL of the format weathersearchengine.com/search?q=location+name, where “location+name” is replaced with a query, the interface 210 would replace “location+name” with the data “New York City” to create the URL weathersearchengine.com/search?q=New+York+City to pass to the weather component.

A source component can have many target components, and a target component can be the target of many source components. As such depending on the frame of reference, a component can be both a source component and a target component. Accordingly, many interesting decisions and emergent behaviors can be based on the interface 210 once a user has a complete view of his or her world. For example, a user may decide to buy the stock of a company because the user deduces that the stock price does not reflect anticipated revenue from recent expansion into locations not served by the company's competitors. Also, a user may decide eat at a chain restaurant only if it is currently snowing outside the restaurant's corporate headquarters. These types of complex patterns would previously require teasing out through many clicks, queries, and switching between applications. However, with the correct coupling of source and target components, the user interface 210 can provide these patterns with only one query in one component. Such efficiencies will provide competitive advantages to businesses implementing the interface 210.

The interface 210 can automatically, i.e., without human input, store all content and layouts. For multiple users, the interface 210 can also be personalized based on the state in which each user left their personal workspace. In at least one embodiment, a snapshot of a target component or layout is automatically, i.e., without human input, taken upon the first update of the target component. Once the snapshot is taken, a thumbnail may be used to find the layout or target component in the toolbox 406. Preferably, an applet takes the snapshot of the component or the layout as a portable network graphics (PNG) file, and the surrounding desktop environment is left out of the snapshot.

In at least one embodiment, a request to disassociate the target component from an event type is received. For example, a user views a list of the event types of the weather component, and the user requests that the “precipitation” event type be deleted. As such, the event type is removed from the plurality of event types. For example, “precipitation” is deleted from the database of event types associated with the weather component. Similarly, a user can add or modify an event type for a specific component or globally for every component. In order to conserve processing, target components are updated only if an event is passed to them.

If the workspace is not sufficient to view a user's world, the workspace can be set to cycle through a number of pages in slideshow mode. Components 402 on different pages can be coupled as if they were on the same page.

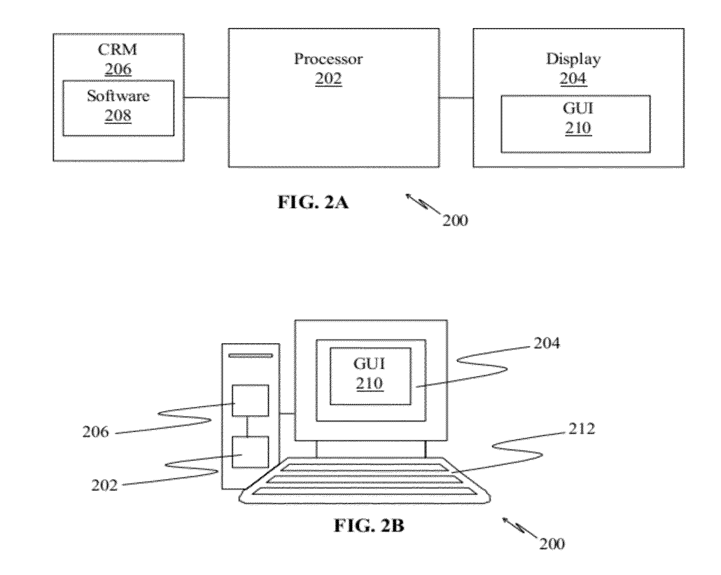

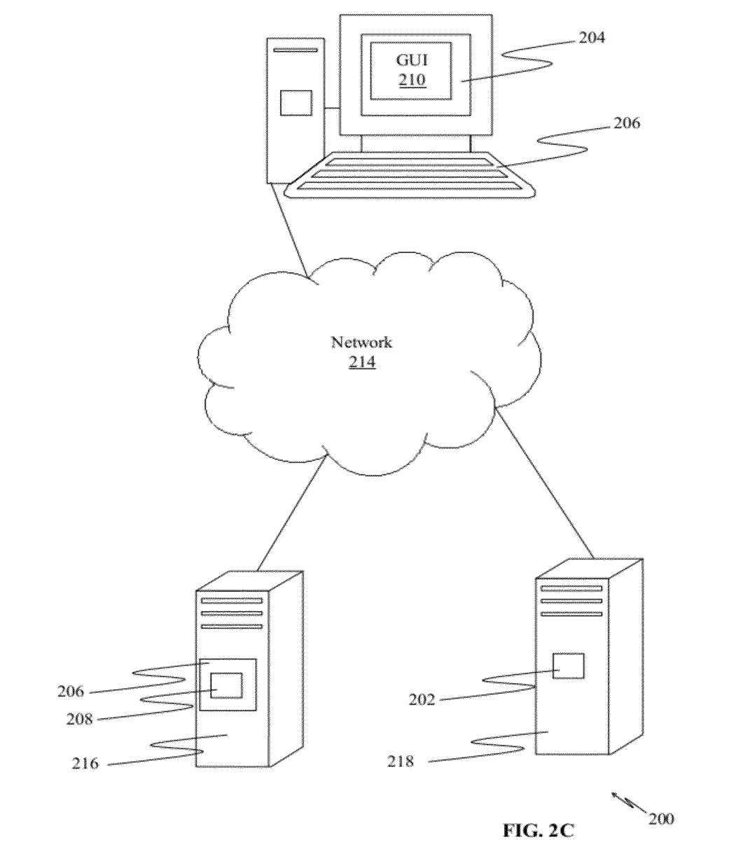

FIG. 2A illustrates a system 200 comprising a computer-readable medium 206 storing software 208 that, when executed by one or more processors 202, causes the processor 202 to perform any of the steps described in this disclosure. The system 200 also comprises a graphical user interface 210 (“GUI”) 210 displayed on display 204. Preferably, the GUI 210 is the point of access between the user and the system 200.

FIG. 2B illustrates the system 200 in at least one embodiment. Specifically, the processor 202 is a computer processor, and the computer-readable medium 206 is coupled to the processor 202 in a computer. The display 204 is a computer monitor, and a user can manipulate the GUI via the keyboard 212 and computer mouse (not shown). In such an embodiment, the processor 202 and computer-readable medium 206 are local. Turning to FIG. 2C, components of the system 200 are distributed over a network 214 in at least one embodiment. Specifically, the user interacts with the GUI 210, and transmits information over the network 214 for processing by servers 216, 218. Preferably, the network 214 is the Internet. Server 218 comprises a processor 202 that executes software 208 located on a computer-readable medium 206 of server 216. Many configurations and combinations of distributed computing are possible.

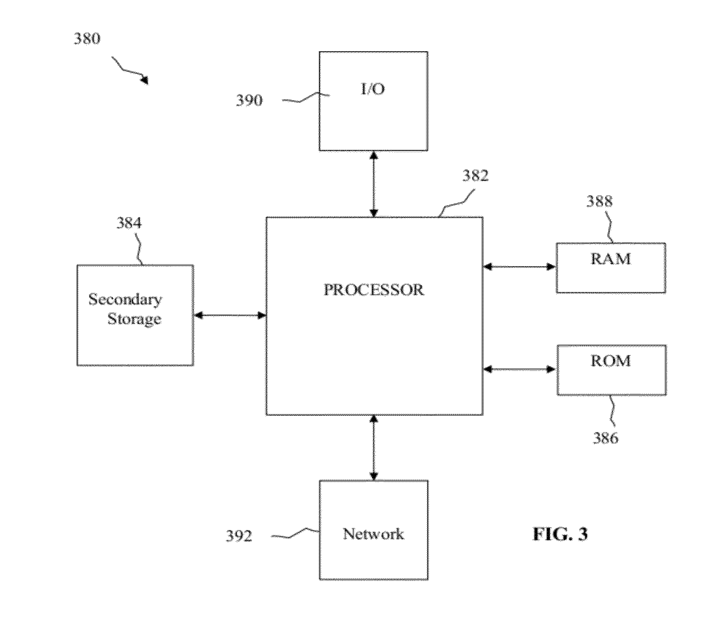

The system described above may be implemented on a particular machine with sufficient processing power, memory resources, and network throughput capability to handle the necessary workload placed upon it. FIG. 3 illustrates a particular computer system 380 suitable for implementing one or more embodiments disclosed herein. The computer system 380 includes a processor 382 (which may be referred to as a central processor unit or CPU) that is in communication with memory devices including secondary storage 384, read only memory (ROM) 386, random access memory (RAM) 388, input/output (I/O) 390 devices, and network connectivity devices 392. The processor may be implemented as one or more CPU chips.

The secondary storage 384 is typically comprised of one or more disk drives or tape drives and is used for non-volatile storage of data and as an over-flow data storage device if RAM 388 is not large enough to hold all working data. Secondary storage 384 may be used to store programs that are loaded into RAM 388 when such programs are selected for execution. The ROM 386 is used to store instructions and perhaps data that are read during program execution. ROM 386 is a non-volatile memory device which typically has a small memory capacity relative to the larger memory capacity of secondary storage. The RAM 388 is used to store volatile data and perhaps to store instructions. Access to both ROM 386 and RAM 388 is typically faster than to secondary storage 384.

I/O 390 devices may include printers, video monitors, liquid crystal displays (LCDs), touch screen displays, keyboards, keypads, switches, dials, mice, track balls, voice recognizers, card readers, paper tape readers, or other well-known input devices. The network connectivity devices 392 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards such as code division multiple access (CDMA) and/or global system for mobile communications (GSM) radio transceiver cards, and other well-known network devices. These network connectivity 392 devices may enable the processor 382 to communicate with an Internet or one or more intranets. With such a network connection, it is contemplated that the processor 382 might receive information from the network, or might output information to the network in the course of performing the above-described method steps. Such information, which is often represented as a sequence of instructions to be executed using processor 382, may be received from and outputted to the network, for example, in the form of a computer data signal embodied in a carrier wave

Such information, which may include data or instructions to be executed using processor 382 for example, may be received from and outputted to the network, for example, in the form of a computer data baseband signal or signal embodied in a carrier wave. The baseband signal or signal embodied in the carrier wave generated by the network connectivity 392 devices may propagate in or on the surface of electrical conductors, in coaxial cables, in waveguides, in optical media, for example optical fiber, or in the air or free space. The information contained in the baseband signal or signal embedded in the carrier wave may be ordered according to different sequences, as may be desirable for either processing or generating the information or transmitting or receiving the information. The baseband signal or signal embedded in the carrier wave, or other types of signals currently used or hereafter developed, referred to herein as the transmission medium, may be generated according to several methods well known to one skilled in the art.

The processor 382 executes instructions, codes, computer programs, scripts which it accesses from hard disk, floppy disk, optical disk (these various disk based systems may all be considered secondary storage 384), ROM 386, RAM 388, or the network connectivity devices 392.

The above disclosure is meant to be illustrative of the principles and various embodiment of the present invention. Numerous variations and modifications will become apparent to those skilled in the art once the above disclosure is fully appreciated. Additionally, audio or visual alerts may be triggered upon successful completion of any action described herein, upon unsuccessful actions described herein, and upon errors. Also, the order of the actions shown in FIG. 1 can be varied from order shown, and two or more of the actions may be performed concurrently. It is intended that the following claims be interpreted to embrace all variations and modifications.

What is claimed is:

1. A machine-readable storage medium comprising executable instructions that, when executed, cause one or more processors to:
receive selection of a source component in a user interface mashup;
receive selection of a target component in the user interface mashup, the target component associated with a plurality of event types;
receive a first event from the source component, the first event associated with a first event type;
compare the first event type with the plurality of event types;
pass the first event to the target component if the plurality of event types comprises the first event type.

2. The storage medium of claim 1, wherein the one or more processors are further caused to automatically take a snapshot of the target component upon update of the target component, the snapshot presented as a thumbnail for use in selecting the target component.

3. The storage medium of claim 1, wherein the one or more processors are further caused to
receive a request to disassociate the target component from an event type out of the plurality of event types;
remove the event type from the plurality of event types.

4. The storage medium of claim 1, wherein the one or more processors are further caused to update the target component only if the first event is passed to the target component.

5. The storage medium of claim 1, wherein the one or more processors are further caused to block the first event from passing to the target component if the plurality of event types does not comprise the first event type.

6. The storage medium of claim 1, wherein passing the first event comprises passing a JavaScript event to the target component.

7. The storage medium of claim 1, wherein the source component is written in a language different from the target component.

8. A method, comprising:
receiving selection of a source component in a user interface mashup;
receiving selection of a target component in the user interface mashup, the target component associated with a plurality of event types;
receiving a first event from the source component, the first event associated with a first event type;
comparing the first event type with the plurality of event types;
passing the first event to the target component if the plurality of event types comprises the first event type.

9. The method of claim 8, further comprising automatically take a snapshot of the target component upon update of the target component, the snapshot presented as a thumbnail for use in selecting the target component.

10. The method of claim 8, further comprising
receiving a request to disassociate the target component from an event type out of the plurality of event types;
removing the event type from the plurality of event types.

11. The method of claim 8, wherein the source component is written in a language different from the target component.

12. The method of claim 8, further comprising blocking the first event from passing to the target component if the plurality of event types does not comprise the first event type.

13. The method of claim 8, wherein passing the first event comprises passing a JavaScript event to the target component.

14. The method of claim 8, wherein passing the first event comprises generating a universal resource locater based on the first event and the target component.

15. A device, comprising:
a processor;
a memory coupled to the processor;
wherein the processor
receives selection of a source component in a user interface mashup;
receives selection of a target component in the user interface mashup, the target component associated with a plurality of event types in the memory;
receives a first event from the source component, the first event associated with a first event type;
compares the first event type with the plurality of event types in the memory;
passes the first event to the target component if the plurality of event types comprises the first event type.

16. The device of claim 15, wherein the processor automatically takes a snapshot of the target component upon update of the target component, the snapshot presented as a thumbnail for use in selecting the target component.

17. The device of claim 15, wherein the processor
receives a request to disassociate the target component from an event type out of the plurality of event types;
removes the event type from the plurality of event types.

18. The device of claim 15, wherein the source component is written in a language different from the target component.

19. The device of claim 15, wherein the processor blocks the first event from passing to the target component if the plurality of event types does not comprise the first event type.

20. The device of claim 15, wherein passing the first event comprises the processor generating a universal resource locater based on the first event and the target component.
